(19) United States
(12) Patent Application Publication
(10) Pub. No.: US 2026/0236662 A1
(43) Pub. Date: Aug. 13, 2026

(54) METHOD AND DEVICE WITH CIRCUIT DESIGN

(71) Applicant: Samsung Electronics Co., Ltd., Suwon-si (KR)

(72) Inventors: Kyunghwan SON, Suwon-si (KR); Hyung-Dal KWON, Suwon-si (KR); Minjun KIM, Suwon-si (KR); Inho ROH, Suwon-si (KR); Bosun HWANG, Suwon-si (KR)

(73) Assignee: Samsung Electronics Co., Ltd., Suwon-si (KR)

(21) Appl. No.: 19/403,712

(22) Filed: Nov. 28, 2025

(30) Foreign Application Priority Data
Feb. 7, 2025 (KR) 10-2025-0016107

(51) Int. Cl. G06F 30/398; G06F 30/392; G06F 30/3953; G06F 111/10

(52) U.S. Cl. CPC G06F 30/398; G06F 30/392; G06F 30/3953; G06F 2111/10

(57) ABSTRACT

A circuit design method includes: receiving a circuit graph; based on the circuit graph, generating circuit data including node information for nodes in the circuit graph and a hyperedge defining connection relationships between the nodes; encoding the circuit data through a graph neural network to generate feature data for a policy module; generating circuit placement data for the nodes based on the policy module and the feature data; generating a total wiring length for the circuit placement data based on the circuit placement data; and determining whether a termination criterion for additional generation of the circuit placement data is satisfied.

### CROSS-REFERENCE TO RELATED APPLICATIONS

This application claims priority to and the benefit of Korean Patent Application No. 10-2025-0016107 filed with the Korean Patent Office on Feb. 7, 2025, the entire contents of which are incorporated herein by reference.

### BACKGROUND

### 1. Field

The present disclosure relates to a method and device with circuit design.

### 2. Description of Related Art

To design an integrated circuit, various conditions must be satisfied, and the optimal arrangement of circuit elements must be found to improve the performance of the integrated circuit. For example, there is a difficulty in circuit design that requires significant resources to find the optimal placement for circuit elements while satisfying conditions such as, for example, the size of the cell in the integrated circuit, the port, and whether it is a macro cell.

Recently, there have been attempts to improve design efficiency by utilizing artificial intelligence models in circuit design. However, as the number of circuit elements deployed increases due to the advancement of integrated circuit performance, the use of some artificial intelligence models may not be suitable for circuit design or may require a prohibitive amount of resources if used. Selecting an efficient artificial intelligence model for circuit design is becoming increasingly important.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some embodiments provide circuit design methods and circuit design devices for efficiently searching for optimal placement for large-scale circuit elements.

Some embodiments provide a circuit design method and circuit design device for efficiently searching for optimal placement for circuit elements while reflecting node information and design constraints.

In one general aspect, a circuit design method includes: receiving a circuit graph; based on the circuit graph, generating circuit data including node information for nodes in the circuit graph and a hyperedge defining connection relationships between the nodes; encoding the circuit data through a graph neural network to generate feature data for a policy module; generating circuit placement data for the nodes based on the policy module and the feature data; generating a total wiring length for the circuit placement data based on the circuit placement data; and determining whether a termination criterion for additional generation of the circuit placement data is satisfied.

The node information may include, for each of the nodes, the size of the node, the number of ports of the node, whether the node is a group, whether the node is flipped, and whether the node is a macro cell.

The hyperedge may include connection information indicating connections between the nodes and at least one of an adjacency matrix and an incidence matrix.

The generating the feature data may include the graph neural network receiving the circuit data and encoding the circuit data, wherein the number of dimensions of the feature data is lower than the number of dimensions of the circuit data.

The graph neural network may include a HGNN (Hypergraph Neural Network), an HCHA (Hypergraph Convolution via Hyperedge Attention) neural network, a HyperGCN (Hypergraph Convolutional Network), or a Hyper-SAGN (Hypergraph Self-Attention Graph Neural Network).

The generating the total wiring length may include generating the number of maximum congestion wires corresponding to the circuit placement data, the circuit placement data may be used as an action in a reinforcement learning process, and the total wiring length and the number of maximum congestion wires may be used as rewards of the reinforcement learning process.

The determining whether the termination criterion for additional generation of the circuit placement data is satisfied may include checking whether the following equation is satisfied: TWL(IDPd)<TH1 and MC(1DPd)<TH2, wherein IDPd is the circuit placement data, TWL is the total wiring length, the MC is the number of maximum congestion wires, and TH1 and TH2 are predetermined constants.

The circuit design method may further include: performing a learning operation based on the circuit placement data and the total wiring length in response to not satisfying the termination criterion; updating the policy module based on the learning operation; and generating the circuit placement data and the total wiring length based on the updated policy module.

The circuit design method may further include: performing a post-processing operation on the circuit placement data to generate post-processing circuit placement data; wherein the post-processing circuit placement data and the circuit placement data are provided to an environment module.

The post-processing operation may include changing the arrangement of nodes in the circuit placement data and the arrangement order of the nodes based on the node information.

In another general aspect, a circuit design device includes: one or more processors and a memory storing code configured to, when executed by the one or more processors, cause the circuit design device to perform a process including: receiving a circuit graph; based on the circuit graph, generating circuit data including node information for nodes in the circuit graph and a hyperedge defining connection relationships between the nodes; encoding the circuit data through a graph neural network to generate feature data for a policy module; generating circuit placement data for the nodes based on the policy module and the feature data; generating a total wiring length for the circuit placement data based on the circuit placement data; and determining whether a termination criterion for additional generation of the circuit placement data is satisfied.

The node information may include, for each of the nodes, the size of the node, the number of ports of the node, whether the node is a group, whether the node is flipped, and whether the node is a macro cell.

The hyperedge may include connection information indicating connections between the nodes and at least one of an adjacency matrix and an incidence matrix.

The generating the feature data may include the graph neural network receiving the circuit data and encoding the circuit data, and the number of dimensions of the feature data may be lower than the number of dimensions of the circuit data.

The graph neural network may include an HGNN, an HCHA network, a HyperGCN, or a Hyper-SAGN.

The generating the total wiring length may include generating the number of maximum congestion wires corresponding to the circuit placement data, wherein the circuit placement data may be used as an action of a reinforcement learning process, and wherein the total wiring length and the number of maximum congestion wires may be used as rewards of the reinforcement learning process.

The process may further include: in response to not satisfying the termination criterion, performing a learning operation based on the circuit placement data and the total wiring length; updating the policy module based on the learning operation; and generating the circuit placement data and the total wiring length based on the updated policy module.

The process may further include performing a post-processing operation on the circuit placement data based on the node information to generate post-processing circuit placement data, and the post-processing operation may include changing arrangement of nodes in the circuit placement data or changing arrangement order of the nodes based on the node information.

In another general aspect, a circuit design device includes: an environment module configured to receive a circuit graph and generate, based on the circuit graph, circuit data including node information for nodes in the circuit graph and a hyperedge defining connection relationships between the nodes; and an agent module configured to encode the circuit data through a graph neural network to generate feature data for a policy module, output circuit placement data for the nodes based on the policy module and the feature data, receive a total wiring length of the circuit placement data, and perform learning for the policy module based on the circuit placement data and the total wiring length.

The environment module may be configured to receive the circuit placement data, generate the total wiring length and the number of maximum congestion wires corresponding to the circuit placement data, and provide the total wiring length and the number of maximum congestion wires to the agent module.

According to some embodiments of the present disclosure, a circuit design method and a circuit design device can efficiently search for an optimal placement of large-scale circuit elements and readily reflect node information and design constraints in the placement of the circuit elements.

Other features and aspects will be apparent from the following detailed description, the drawings, and the claims.

### BRIEF DESCRIPTION OF THE DRAWINGS

FIG. 1 illustrates a circuit design device according to one or more embodiments.

FIG. 2 illustrates a circuit design system according to one or more embodiments.

FIG. 3 illustrates a circuit design method according to one or more embodiments.

FIGS. 4 to 10 illustrate circuit design methods according to one or more embodiments.

FIG. 11 illustrates a circuit design system according to one or more embodiments.

FIG. 12 illustrates a circuit design method according to one or more embodiments.

FIGS. 13 and 14 illustrate circuit design methods according to one or more embodiments.

Throughout the drawings and the detailed description, unless otherwise described or provided, the or like same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

An artificial intelligence (AI) model executed in a neural network as described herein is a machine learning model that learns at least one task, and may be implemented as a computer program executed by a processor or accelerator. The task learned by the artificial intelligence model may be a problem to be solved through machine learning or a task to be performed through machine learning. Artificial intelligence models may be implemented as computer programs that run on computing devices, downloaded over a network, or sold in product form. Alternatively, the AI model may be connected to various devices over a network.

Herein, the terms neural network, computational model, network function, and neural network are used interchangeably. A neural network may consist of a collection of interconnected computational units, which may generally be referred to as nodes. A neural network may contain at least one node. The nodes that make up a neural network may be interconnected by one or more links, usually, in the form of connections between layers of the nodes.

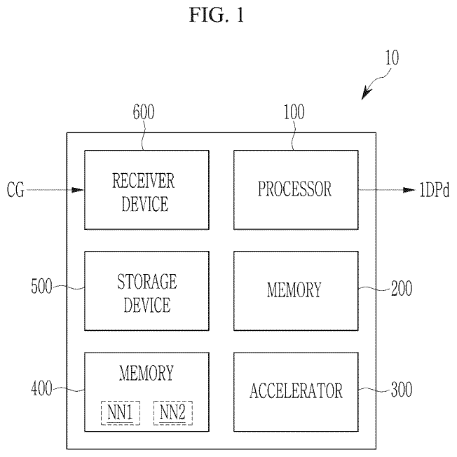

FIG. 1 illustrates a circuit design device according to one or more embodiments.

Referring to FIG. 1, a circuit design device 10 may perform circuit design through a reinforcement learning process. The circuit design device 10 may receive a circuit graph CG corresponding to a circuit structure and generate a target circuit structure based thereon.

A circuit graph CG may be a data structure composed of points and lines. The circuit graph CG may have directed and acyclic characteristics. A point may be referred to as a node, and a line may be referred to as an edge. A node may correspond to a circuit element that is constituted in the circuit represented by the circuit graph CG; a node may be a standard cell. Edges may correspond to wires connecting circuit elements.

Reinforcement learning is a branch of machine learning in which an agent defined in a parameterized environment recognizes the current state of the environment and selects an action or action sequence that maximizes reward among selectable actions.

T circuit design device 10 may place a circuit of a circuit graph CG (which is expressed by nodes corresponding to circuit elements and edges connected to the nodes) in one dimension (e.g., a plane) through a reinforcement learning process (the techniques described herein are readily extended to circuit graphs with more than one dimension). The circuit design device 10 may generate a 1-dimension placement/arrangement of a circuit structure in which node information is reflected and the length of an edge is minimized through a reinforcement learning process. That is, the circuit design device 10 may generate a circuit arrangement that reflects design constraints and has at least a 1-dimensional total wiring length arranged in the circuit.

The circuit design device 10 may place circuit elements that perform predetermined functions in predetermined areas to design an integrated circuit. For example, the circuit design device 10 may generate a circuit arrangement of circuit elements in a row in a peripheral area of a memory. That is, when blocks for controlling the operation of memory elements (e.g., electronic components constituting a control unit) are placed in a peripheral area within a memory device, a reinforcement learning process may be used so that information and design constraints of circuit elements are reflected in the circuit layout, and the length of wiring connecting each component may be minimized.

In implementations where circuit elements need to be arranged 1-dimensionally within a peripheral area within a memory device, the arrangement order of the circuit elements may be encoded in the form of a numeric string or vector.

The circuit design device 10 may process a circuit graph CG including a conceptual circuit structure through a reinforcement learning process to generate 1-dimension circuit placement data 1DPd, which is an optimized target circuit structure. For example, the circuit design device 10 may generate a state of a reinforcement learning process based on a circuit graph CG, and generate and learn an action and a reward for the action based on the state to generate 1-dimension circuit placement data 1DPd.

The circuit design device 10 may be implemented in a personal computer (PC), a data server, a portable device, a cloud service, or the like.

The portable device may be implemented as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device (PND) or portable navigation device (PND), a handheld game console, an e-book, or a smart device, as non-limiting examples. A smart device may be a smart watch, a smart band, or a smart ring, for example.

The circuit design device 10 may include a processor 100, a first memory 200, an accelerator 300, a second memory 400, a storage device 500, and a receiver device 600.

The receiver device 600 may include a receiving interface (e.g., a network interface, a bus interface, or the like). The receiver device 600 may receive a circuit graph CG corresponding to the circuit structure. The receiver device 600 may receive data such as a circuit graph CG from an external device or storage device 500. The receiver device 600 may provide the received circuit graph CG to the processor 100. The receiver device 600 may include a communication interface device that is connected to a network and performs communication, and the communication interface device may be a wired interface, a wireless interface, a Bluetooth interface, or an optical interface, as non-limiting examples.

The processor 100 may control the circuit design device 10 overall. The processor 100 may execute at least one program (or code) stored in the first memory 200. The circuit design device 10 may perform the circuit design method of the present disclosure by having the processor 100 execute at least one program stored in the first memory 200.

The processor 100 may control components within the circuit design device 10 to operate by executing at least one program while the circuit design device 10 performs a reinforcement learning process. For example, while the circuit design device 10 performs the circuit design method, the processor 100 may control the accelerator 300 to perform operations of the neural networks NN1, NN2 loaded into the second memory 400 (not necessarily all at once).

There may be one or more processors 100. One or more processors according to the present disclosure may include a general-purpose processor such as a Central Processing Unit (CPU), a Graphics Processing Unit (GPU), an Accelerated Processing Unit (APU), a Many Integrated Core (MIC), a Digital Signal Processor (DSP), and a Neural Processing Unit (NPU), or a dedicated processor on which an operation method according to an embodiment of the present disclosure is performed. One or more processors may be implemented in the form of an integrated system on a chip (SoC) including one or more electronic components. Each of the one or more processors may be implemented as separate hardware H/W.

The processor 100 may receive a circuit graph CG from a receiver device 600 and generate circuit data based on the circuit graph CG. Circuit data may include node information for the nodes corresponding to circuit elements in a circuit graph CG and a hyperedge including connection information of connections between the nodes.

The above node information may include, but is not limited to, for each cell, the type of standard cell of the corresponding node, the size of the corresponding node, the number of ports of the corresponding node, whether the corresponding node is a group (or, the group to which the node belongs), whether the corresponding node is flipped, and/or whether the corresponding node is a macro cell. The above-noted hyperedge may include, but is not limited to, an adjacency matrix and/or an incidence matrix including connection information of connections between the nodes. Related circuit data may be an instance of a state for a reinforcement learning process.

The processor 100 may control the accelerator 300 so that the accelerator 300 may perform an encoding operation on circuit data to generate feature data. The feature data may be input data of a module or another neural network and may be an embedding vector, for example.

The processor 100 may generate 1-dimension circuit placement data based on feature data. According to an embodiment, the processor 100 may compute a probability-based matrix including conditional probabilities for respective features in the feature data, and the processor 100 may perform a sampling operation based on the probability-based matrix to generate 1-dimension circuit placement data. 1-dimension circuit placement data may be an example of an action for a reinforcement learning process. Although the processor 100 is described as generating 1-dimension circuit placement data based on a probability-based matrix, other implementations are possible; the processor 100 may generate 1-dimension circuit placement data through a formula or a neural network inference operation, etc.

The processor 100 may calculate the total wiring length, the number of maximum congestion wires, and the maximum wiring length corresponding to the 1-dimension circuit placement data, any of which may be calculated based on the 1-dimension circuit placement data. The total wiring length, the number of maximum congestion wires, and the maximum wiring length corresponding to 1-dimension circuit placement data may be treated as rewards for the reinforcement learning process.

The processor 100 may determine whether a termination criteria for a reinforcement learning process is satisfied based on compensation for the generated 1-dimension circuit placement data. That is, the processor 100 may check whether the termination criteria for additional generation of actions is satisfied based on the compensation for the generated 1-dimension circuit placement data. In some implementations, the processor 100 may determine whether the termination criteria for the reinforcement learning process are satisfied based on the total wiring length and the number of maximum congestion wires corresponding to the 1-dimension circuit placement data.

The processor 100 may control the accelerator 300 so that the accelerator 300 performs a learning operation based on 1-dimension circuit placement data and based on the total wiring length and the number of maximum congestion wires corresponding to the 1-dimension circuit placement data to generate update data.

In some implementations, the processor 100 may update a probability-based matrix based on the update data. Although the processor 100 has been described as updating based on a probability-based matrix, the processor 100 is not limited thereto and, depending on the implementation, the processor 100 may update coefficients of formulas, weights of a neural network, etc., as non-limiting examples.

The processor 100 may perform a post-processing operation on the generated 1-dimension circuit placement data to generate post-processing 1-dimension circuit placement data. The processor 100 may change the arrangement of nodes and/or the arrangement order of the nodes based on the 1-dimension circuit placement data generated in the post-processing operation.

The first memory 200 may store instructions (or programs, or code) executable by the processor 100. For example, the instructions may include instructions for executing operations of the processor 100 and/or operations of each component of the processor 100. In some implementations, the first memory 200 may be driven as a system memory of the circuit design device 10 (e.g., may be host memory), and the first memory 200 may be connected to the processor 100 through a separate interface or separate bus.

The first memory 200 may be implemented as a volatile memory device or a nonvolatile memory device. Volatile memory devices may be implemented as dynamic random access memory (DRAM), static random access memory (SRAM), thyristor RAM (T-RAM), zero capacitor RAM (Z-RAM), or twin transistor RAM (TTRAM). The nonvolatile memory device may be implemented as an Electrically Erasable Programmable Read-Only Memory (EEPROM), flash memory, Magnetic RAM (MRAM), Spin-Transfer Torque (STT-MRAM) Conductive Bridging RAM (CBRAM), Ferroelectric RAM (FeRAM), Phase change RAM (PRAM), Resistive RAM (RRAM), Nanotube RRAM, Polymer RAM (PoRAM), Nano Floating Gate Memory (NFGM), holographic memory, Molecular Electronic Memory Device, or Insulator Resistance Change Memory, as non-limiting examples.

The accelerator 300 may perform operations on neural networks NN1 and NN2 loaded into the second memory 400. According to an embodiment, the accelerator 300 may perform operations on at least some layers within a neural network(s) NN1 and/or NN2 and to that end may process matrix multiplication or convolution operations in parallel. The accelerator 300 may be, for example, a GPU, an NPU, a CPU, an FPGA (Field-Programmable Gate Array), System on a Chip (SoC), an Application-Specific Integrated Circuits (ASIC), a Vision Processing Units (VPC), a neuromorphic IC, etc., but is not limited thereto.

The accelerator 300 may include multiply-accumulate units (hereinafter referred to as MAC units) capable of processing data operations. The accelerator 300 specifications may be determined based on the number of MAC units included in the accelerator 300. For example, in the case where the number of MAC units is N, N parallel operations may be performed in the accelerator 300.

The accelerator 300 may perform at least a portion of the operations of the aforementioned processor 100 depending on the type of hardware (e.g., CPU, etc.).

The second memory 400 may store one or more instructions and/or programs/code that cause the accelerator 300 to perform neural network operations. The second memory 400 may store the first and second neural networks NN1, NN2. According to an embodiment, the second memory 400 may be connected to the accelerator 300 via a separate interface or separate bus.

The second memory 400 may be implemented as a volatile memory device or a nonvolatile memory device. Volatile memory devices may be implemented as DRAM, SRAM, T-RAM, Z-RAM, or TTRAM. The nonvolatile memory device may be implemented as an EEPROM, flash memory, MRAM, STT-MRAM, CBRAM, FeRAM, PRAM, RRAM, Nanotube RRAM, PoRAM, NFGM, holographic memory, Molecular electronic Memory Device, or Insulator Resistance Change Memory, as non-limiting examples.

The first memory 200 and the second memory 400 are illustrated as separate configurations in FIG. 1, but according to an embodiment, the first memory 200 and the second memory 400 may be implemented as one memory device. In the case where the memory implemented as one memory device, the memory device may support a memory pooling operation.

The first neural network NN1 may perform an encoding operation based on circuit data to generate feature data. The circuit data may represent a state of a reinforcement learning process, and may be used to generate feature data, which is input data inputted to a policy module involved in the reinforcement learning process. The dimension of the feature data may be lower than the dimension of the circuit data.

The first neural network NN1 may be a graph neural network and may learn, in the abstract, individual characteristics of nodes and multi-party relationships for the nodes by utilizing the structural characteristics of the circuit graph CG. The trained first neural network NN1 may encode circuit data through an inference process to generate an embedding vector. According to an embodiment, the first neural network NN1 may be implemented as a Hypergraph Neural Network (HGNN), a Hypergraph Convolution via Hyperedge Attention (HCHA), a Hypergraph Convolutional Network (HyperGCN), and a Hypergraph Self-Attention Graph Neural Network (Hyper-SAGN), or the like, as non-limiting examples.

The second neural network NN2 may be a neural network of the policy network that receives actions and rewards according to the state, and that learns the policy module based on the actions and rewards to implement the optimal policy module. The second neural network NN2 may perform a learning operation for the policy module based on 1-dimension circuit placement data and the total wiring length and/or the number of maximum congestion wires corresponding to the 1-dimension circuit placement data.

The second neural network NN2 may generate update data for the policy module through learning operations. The update data may include probability distribution information for the policy module, coefficients of formulas, or weights of a corresponding neural network.

The policy module may be updated through update data, and the updated policy module 740 may generate optimized 1-dimension circuit placement data 1DPd based on the feature data.

In some embodiments, the second neural network NN2 may be trained based on a Proximal Policy Optimization (PPO) algorithm, a Policy Gradient algorithm, an Advantage Actor-Critic (A2C/A3C) algorithm, a SARSA algorithm, Q-Learning, etc., as non-limiting examples, and the second neural network NN2 may be/include a Fully Connected Network (FCN), a Convolutional Neural Network (CNN), a Recurrent Neural Network (RNN), a Transformer, etc., as non-limiting examples

The storage device 500 may store one or more instructions and/or programs/code processed by the processor 100 and the accelerator 300, and according to an embodiment, the storage device 500 may store a circuit graph CG.

The storage device 500 may include a non-volatile storage medium. For example, the storage device 500 may include at least one storage medium among flash memory, a hard disk, a multimedia micro card, a card-type memory (e.g., SD or XD memory, etc.), a RAM, a SRAM, a ROM, an EEPROM, a PROM, a magnetic memory, a magnetic disk, and an optical disk, as non-limiting examples.

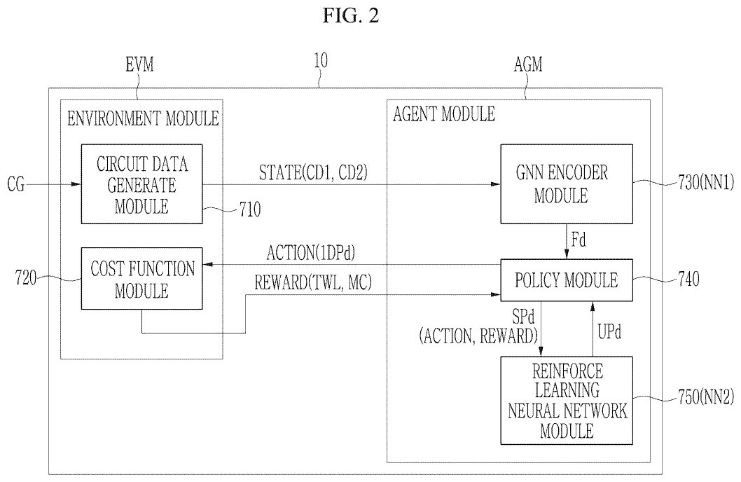

FIG. 2 illustrates a circuit design system according to one or more embodiments.

Referring to FIG. 2, the circuit design device 10 may include an environment module EVM and an agent module AGM. The environment module EVM and the agent module AGM are modules of a circuit design system implemented in a circuit design device 10, and may interact with each other in a reinforcement learning process to generate optimal 1-dimension circuit placement data 1DPd.

In a reinforcement learning process of some embodiments, an environment module EVM and an agent module AGM may be given, and data may be directly collected when the agent module AGM performs an action ACTION in the environment module EVM. That is, in the reinforcement learning process, the agent module AGM may take some action in the current state, and the environment module EVM may return the next state and reward according to the action to the agent module AGM. According to an embodiment, the environment module EVM may provide a fixed state STATE, the agent module AGM may take an action ACTION in the state STATE, and the environment module EVM may return a reward REWARD according to the action ACTION to the agent module AGM.

The basic components of the reinforcement learning process may be organized as shown in the equation 1 below, and this type of modeling is called Markov Decision Process (MDP).

$$[ S , A , R ( s , {s}^{′} ) , P ( s , {s}^{′} ) , γ ] \qquad Equation 1$$

In Equation 1, S represents a set of states, A represents a set of actions, R represents a set of rewards, R(s, s′) represents the reward obtained when moving from the current state s to the next state s′ by an action, P(s, s′) represents the transition probability of moving from the current state s to the next state s′, and γ represents a discount factor that determines the importance of the current reward and future reward.

In some implementations of the reinforcement learning processes, S is fixed, and the current state s and the next state s′ may be the same. R(s, s′) is determined by actions, and state transitions may not occur.

The reinforcement learning process aims to find a strategy that maximizes reward. In more precise terms, reinforcement learning expresses a strategy for deciding how to act in the current state as a policy, and the goal of learning is to find the optimal policy. To find the optimal policy, reinforcement learning uses the concepts of a state-value function and an action-value function. The policy may correspond to a policy module 740 of an agent module AGM.

The state value function represents the goodness or badness of the current state, and the value of the current state is expressed as the average of the sum of some future rewards. The importance of the future rewards changes depending on the discount factor, which is assigned a value between 0 and 1. As noted, the action-value function represents the goodness or badness of the current action, where the expected value of taking a certain action when following a policy in a certain state is expressed as the average of the sum of future rewards, and the importance of future rewards may also vary depending on the discount factor. An action-value function quantitatively represents the value of an action given the current state. The policy module 740 of the agent module AGM may be learned based on an action-value function.

Each environment module EVM and agent module AGM may be implemented by the processor 100 and the accelerator 300 of FIG. 1, or by a program loaded into the first and second memories 200, 400 of FIG. 1, or by a combination of the processor 100 and the accelerator 300 and the loaded program.

The environment module EVM may include a circuit data generation module 710 and a cost function module 720.

A circuit data generation module 710 may receive a circuit graph CG defining a circuit structure in which circuit elements are connected, and based thereon may generate first and second circuit data CD1, CD2 and provide them to an agent module AGM. The first and second circuit data CD1, CD2 are states STATE of a reinforcement learning process, and the circuit data generation module 710 may generate the first and second circuit data CD1, CD2 corresponding to one circuit graph CG. According to an embodiment, the first and second circuit data CD1, CD2 may vary in response to the circuit graph CG (i.e., are not the same), and in the case where the circuit graph CG is fixed, the first and second circuit data CD1, CD2 may be fixed (or, determinate for the circuit graph CG).

The first circuit data CD1 may include node information for nodes representing corresponding circuit elements in a circuit graph CG, and the node information may include, but is not limited to, the type of standard cell for each node, the size of each node, the number of ports of each node, whether each node is a group, whether each node is flipped, whether each node is a macro cell, and/or the like.

The circuit data generation module 710 may include a standard cell library. The circuit data generation module 710 may generate node information for a node based on the standard cell library and the type of standard cell corresponding to the node in the node information.

The second circuit data CD2 may include a hyper-edge including connection information between nodes, and the hyper-edge may include, but is not limited to, an adjacency matrix and/or an incidence matrix including connection information of connections between nodes.

The cost function module 720 receives 1-dimension circuit placement data 1DPd from the agent module AGM and may calculate the total wiring length TWL, the number of maximum congestion wires MC, and the maximum wiring length corresponding to the 1-dimension circuit placement data 1DPd.

The cost function module 720 may provide the calculated total wiring length TWL, the number of maximum congestion wires MC, and the maximum wiring length to the agent module AGM. 1-dimension circuit placement data 1DPd provided from an agent module AGM may be an action ACTION of a reinforcement learning process, and the total wiring length TWL, the number of maximum congestion wires MC, and the maximum wiring length generated from a cost function module 720 may be a reward REWARD for the action ACTION.

Total wiring length TWL is the sum total of wires laid out in a circuit structure generated by 1-dimension circuit placement data 1DPd. The number of maximum congestion wires MC is the maximum number of wirings spaced parallel to each other on a single circuit element in a circuit structure generated by 1-dimension circuit placement data 1DPd. The maximum wiring length is the length of the longest wiring among the wirings laid out in the circuit structure generated by the 1-dimension circuit placement data 1DPd.

The cost function module 720 may check whether the termination criteria for the reinforcement learning process is satisfied, which may be determined based on the total wiring length TWL and the number of maximum congestion wires MC.

The termination criteria for the reinforcement learning process may be based on the number of 1-dimension circuit placement data 1DPd satisfying the Equation 2. In some embodiments, the cost function module 720 may check whether the 1-dimension circuit placement data 1DPd satisfies Equation 2, and may check whether the number of 1-dimension circuit placement data 1DPd (i.e., the number of circuit designs) satisfying the following equation 2 is greater than or equal to a predetermined number.

$$TWL ( IDPd ) < TH 1 , \qquad Equation 2$$

$$MC ( 1 DPd ) < TH 2$$

In Equation 2, IDPd is 1-dimension circuit placement data 1DPd, TWL(IDPd) is a total wiring length TWL corresponding to the 1-dimension circuit placement data 1DPd, MC(1DPd) is a number of maximum congestion wires MC corresponding to the 1-dimension circuit placement data 1DPd, and the TH1 and TH2 are predetermined constants.

The termination criteria for the reinforcement learning process may be based on the number of 1-dimension circuit placement data 1DPd (the number of distinct circuits) provided from the agent module AGM. The cost function module 720 may determine whether a termination criteria for a reinforcement learning process is satisfied based on the number of 1-dimension circuit placement data 1DPd provided from the agent module AGM.

The cost function module 720 may provide termination data for additional generation of 1-dimension circuit placement data 1DPd to the agent module AGM upon confirmation of satisfaction of the termination criteria for the reinforcement learning process.

The agent module AGM may include a GNN encoder module 730, a policy module 740, and a reinforcement learning neural network 750.

The GNN encoder module 730 receives the first and second circuit data CD1, CD2, which are states STATE of the reinforcement learning process, and performs an encoding operation based on the first and second circuit data CD1, CD2, thereby generating feature data Fd, which is input data of the policy module 740. The dimension of the feature data Fd may be lower than the dimensions of the first and second circuit data CD1, CD2.

The GNN encoder module 730 may include a graph neural network, and the graph neural network may include a pre-trained neural network corresponding to the first neural network NN1. The GNN encoder module 730 may encode the first and second circuit data CD1, CD2 to generate feature data Fd, which is an embedding vector. The GNN encoder module 730 may be/include a HGNN, a HCHA, a HyperGCN, and/or a Hyper-SAGN, as non-limiting examples.

Through the encoding operation of the GNN encoder module 730, the circuit design device 10 may efficiently search for the optimal arrangement of a large-scale circuit structure including circuit elements.

The policy module 740 is a strategy or rule module that generates 1-dimension circuit placement data 1DPd, which is an action, based on feature data Fd, which is a state STATE of the reinforcement learning process. The policy module 740 may include a probability-based matrix including conditional probabilities of 1-dimension circuit placement data 1DPd for feature data Fd, and the policy module 740 may perform a sampling operation based on the probability-based matrix to generate 1-dimension circuit placement data 1DPd.

In some embodiments, the policy module 740 may include a neural network without including a probability-based matrix, and may approximate the conditional probability of 1-dimension circuit placement data 1DPd for feature data Fd through the output of the neural network and generate a probability distribution or 1-dimension circuit placement data 1DPd.

The policy module 740 may receive update data UPd from the reinforcement learning neural network 750 and update a probability-based matrix accordingly. According to an embodiment, the policy module 740 may receive update data UPd from the reinforcement learning neural network 750 and update the coefficients of the internal function or the weights of the neural network.

The reinforcement learning neural network 750 may be/include a neural network of a policy network. The reinforcement learning neural network 750 receives 1-dimension circuit placement data 1DPd, which is an action ACTION of a reinforcement learning process, and a total wiring length TWL and a number of maximum congestion wires MC corresponding to 1-dimension circuit placement data 1DPd, which is a reward REWARD, and learns a policy module 740 based on sample data SPd including an action ACTION and a reward REWARD to generate update data UPd for the policy module 740. The reinforcement learning neural network 750 may perform a learning operation on a policy module 740 based on 1-dimension circuit placement data 1DPd and a total wiring length TWL and a number of maximum congestion wires MC corresponding to the 1-dimension circuit placement data 1DPd to generate update data UPd for the policy module 740.

The update data UPd may include probability distribution information for the policy module 740, coefficients of a formula, and/or weights of a neural network.

In some embodiments, the reinforcement learning neural network 750 may include a neural network corresponding to the second neural network NN2. The reinforcement learning neural network 750 may be trained based on a PPO algorithm, a Policy Gradient algorithm, an A2C/A3C algorithm, a SARSA algorithm, Q-Learning, etc., as non-limiting examples, and the reinforcement learning neural network 750 may be/include a FCN, a CNN, a RNN, a Transformer, etc., as non-limiting examples.

By learning the policy module 740 of the reinforcement learning neural network 750, the circuit design device 10 may become capable of generating 1-dimension circuit placement data 1DPd for a circuit graph CG that reflects design constraints such as node information and the number of maximum congestion wires MC and that minimizes the total wiring length TWL.

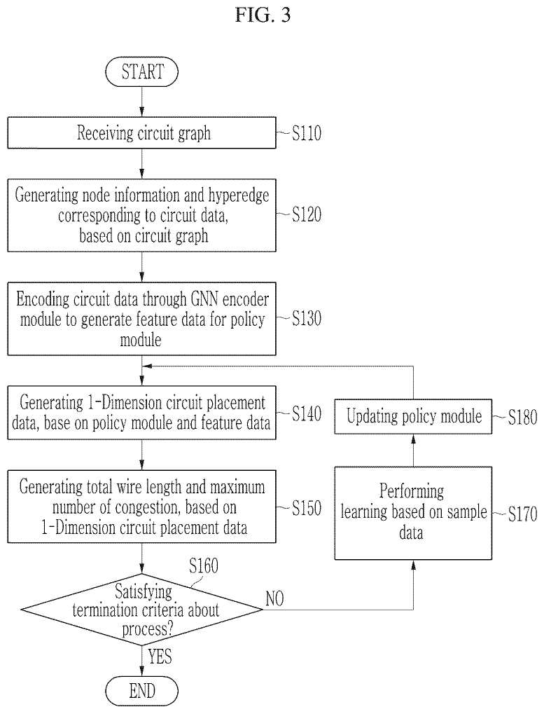

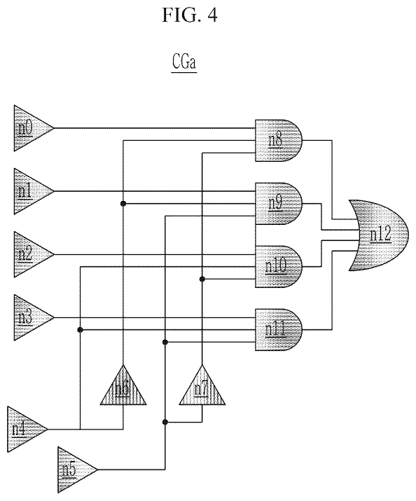

FIG. 3 illustrates a circuit design method according to one or more embodiments. FIGS. 4 to 10 illustrate circuit design methods according to one or more embodiments. Specifically, FIG. 3 illustrates a circuit design method through a reinforcement learning process.

Referring to FIGS. 2 and 3, the circuit data generation module 710 initially receives a circuit graph CG (S110).

The circuit graph CGa of FIG. 4 is an example of a circuit graph CG. Referring to FIG. 4 as an example, the circuit data generation module 710 may receive the circuit “a” graph CGa. The circuit “a” graph CGa is a circuit graph corresponding to a 4-to-1 the multiplexer circuit structure, and the circuit “a” graph CGa may include 0th to 12th nodes n0 to n12.

In the example circuit structure of the circuit “a” graph CGa, the 0th node n0 corresponds to (or represents) a buffer, and the output edge of the 0th node n0 is the input edge of the 8th node n8. The 1st node n1 corresponds to a buffer, and the output edge of the 1st node n1 is the input edge of the 9th node n9. The 2nd node n2 corresponds to a buffer, and the output edge of the 2nd node n2 is the input edge of the 10th node n10. The 3rd node n3 also corresponds to a buffer, and the output edge of the 3rd node n3 is the input edge of the 11th node n11.

The 4th node n4 corresponds to a buffer, and the output edge of the 4th node n4 is the input edge of the 6th node n6, the input edge of the 10th node n10, and the input edge of the 11th node n11. The 5th node n5 corresponds to a buffer, and the output edge of the 5th node n5 is connected to the input edge of the 7th node n7, the input edge of the 9th node n9, and the input edge of the 11th node n11.

The 6th node n6 corresponds to an inverter, the input edge of the 6th node n6 is the output edge of the 4th node n4, and the output edge of the 6th node n6 is the input edge of the 8th node n8 and the input edge of the 9th node n9. The 7th node n7 corresponds to an inverter, and the input edge of the 7th node n7 is the output edge of the 5th node n5, and the output edge of the 7th node n7 is the input edge of the 8th node n8 and the input edge of the 10th node n10.

The 8th node n8 corresponds to a logical AND operator, the input edge of the 8th node n8 is the output edge of the 0th node n0, the output edge of the 6th node n6, and the output edge of the 7th node n7, and the output edge of the 8th node n8 is the input edge of the 12th node n12. The 9th node n9 corresponds to a logical AND operator, the input edge of the 9th node n9 is the output edge of the 1st node n1, the output edge of the 5th node n5, and the output edge of the 6th node n6, and the output edge of the 9th node n9 is the input edge of the 12th node n12. The 10th node n10 corresponds to a logical AND operator, the input edge of the 10th node n10 is the output edge of the 2nd node n2, the output edge of the 4th node n4, and the output edge of the 7th node n7, and the output edge of the 10th node n10 is the input edge of the 12th node n12. The 11th node n11 corresponds to a logical AND operator, the input edge of the 11th node n11 is the output edge of the 3rd node n3, the output edge of the 4th node n4, and the output edge of the 5th node n5, and the output edge of the 11th node n11 is the input edge of the 12th node n12.

The 12th node n12 corresponds to a logical OR operator, and the input edge of the 12th node n12 is the output edge of the 8th node n8, the output edge of the 9th node n9, the output edge of the 10th node n10, and the output edge of the 11th node n11.

The circuit data generation module 710 generates first and second circuit data CD1, CD2 based on the circuit graph CG (S120).

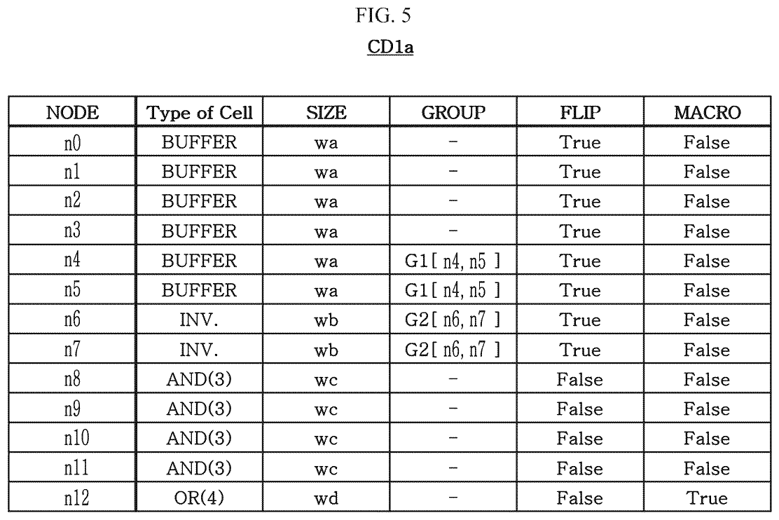

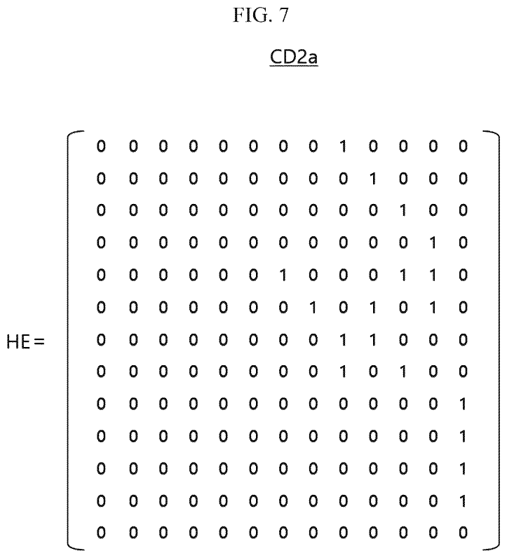

The first_a circuit data CD1a of FIG. 5 is an example of the first circuit data CD1 generated based on the circuit “a” graph CGa, and the second_a circuit data CD2a of FIG. 7 is an example of the second circuit data CD2 generated based on the circuit “a” graph CGa.

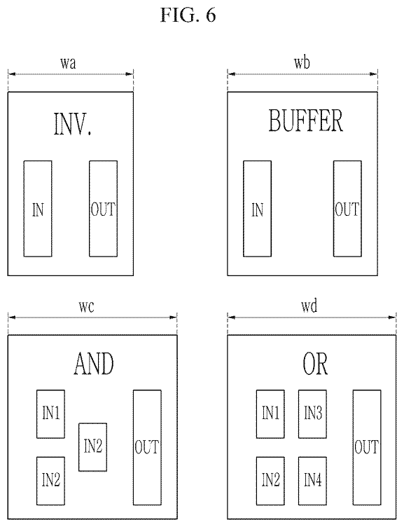

Referring to FIGS. 5 and 6 as examples, the circuit data generation module 710 may generate first_a and second_a circuit data CD1a, CD2a based on the circuit “a” graph CGa.

The first_a circuit data CD1a may include node information for each of the 0th to 12th nodes n0 to n12. The first_a circuit data CD1a may include, for each of the 0th to 12th nodes n0 to n12, in the form of a table, the type, size, number of ports, group information, whether it is a flip, and whether it is a macro cell. The above size refers to the length of the circuit element in one direction and may be determined by the type of standard cell of the corresponding circuit element/node.

The first_a circuit data CD1a may comprise node information for the 0th node n0, and the node information for the 0th node n0 may include a buffer, an a size wa, no group, flip application True, and macro cell non-application False. The a size wa of the buffer may be the length in one direction.

The first_a circuit data CD1a may comprise node information for the 1st node n1, and the node information for the 1st node n1 may include a buffer, an a size wa, no group, flip application True, and macro cell non-application False.

The first_a circuit data CD1a may comprise node information for the 2nd node n2, and node information for the 2nd node n2 may include a buffer, an a size wa, no group, flip application True, and macro cell non-application False.

The first_a circuit data CD1a may comprise node information for the 3rd node n3, and the node information for the 3rd node n3 may include a buffer, an a size wa, no group, flip application True, and macro cell non-application False.

The first_a circuit data CD1a may comprise node information for the 4th node n4, and the node information for the 4th node n4 may include a buffer, an a size wa, a first group G1, flip application True, and macro cell non-application False.

The first_a circuit data CD1a may comprise node information for the 5th node n5, and the node information for the 5th node n5 may include a buffer, an a size wa, a first group G1, flip application True, and macro cell non-application False.

The first_a circuit data CD1a may comprise node information for the 6th node n6, and the node information for the 6th node n6 may include an inverter, a b size wb, a second group G2, flip application True, and macro cell non-application False. The b size wb may be the length of the inverter in one direction.

The first_a circuit data CD1a may comprise node information for the 7th node n7, and the node information for the 7th node n7 may include an inverter, a b size wb, a second group G2, flip application True, and macro cell non-application False.

The first_a circuit data CD1a may comprise node information for the 8th node n8, and node information for the 8th node n8 may include a logical AND operator having three input ports, a c size wc, no group, no flip applied False, and no macro cell applied False. The c size wc is the length in one direction of a AND operator with three input ports.

The first_a circuit data CD1a may comprise node information for the 9th node n9, and node information for the 9th node n9 may include a logical AND operator having three input ports, a c size wc, no group, no flip applied False, and no macro cell applied False.

The first_a circuit data CD1a may comprise node information for the 10th node n10, and node information for the 10th node n10 may include a logical AND operator having three input ports, a c size wc, no group, no flip applied False, and no macro cell applied False.

The first_a circuit data CD1a may comprise node information for the 11th node n11, and node information for the 11th node n11 may include a logical AND operator having three input ports, a c size wc, no group, no flip applied False, and no macro cell applied False.

The first_a circuit data CD1a may comprise node information for the 12th node n12, and node information for the 12th node n12 may include a logical OR operator having four input ports, a d size wd, no group, no flip applied False, and a macro cell applied True. The d size wd is the length in one direction of a logical OR operator with four input ports.

The second_a circuit data CD2a may include a hyperedge including a connection line between the 0th to 12th nodes n0 to n12. In some embodiments, a hyper-edge may include at least one of an adjacency matrix and an incidence matrix.

Referring to FIG. 4 and FIG. 7 as examples, the second_a circuit data CD2a may include a hyperedge HE which is an adjacency matrix, and the elements of the hyperedge HE may be as shown in the equation 3 below.

### Equation 3

$$HE ( i + 1 , j + 1 ) ) = \begin{matrix}1 ( ni \to nj ) \\ 0 ( ni \to nj ) /\end{matrix} \qquad Equation 3$$

In Equation 3, ni is the ith node, nj is the jth node, and i and j are integers from 0 to 12.

Referring to FIG. 7 as an example, since the output edge of the 0th node n0 is the input edge of the 8th node n8, HE(1, 9) is 1, and since the output edge of the 8th node n8 is not the input edge of the 0th node n0, HE(9, 1) is 0.

The GNN encoder module 730 encodes the first and second circuit data CD1, CD2 to generate feature data Fd for the policy module 740 (S130), which may be receives from the environment module EVM.

The first neural network NN1 of the GNN encoder module 730 may encode the first and second circuit data CD1, CD2 to generate feature data Fd, which is an embedding vector of the circuit data.

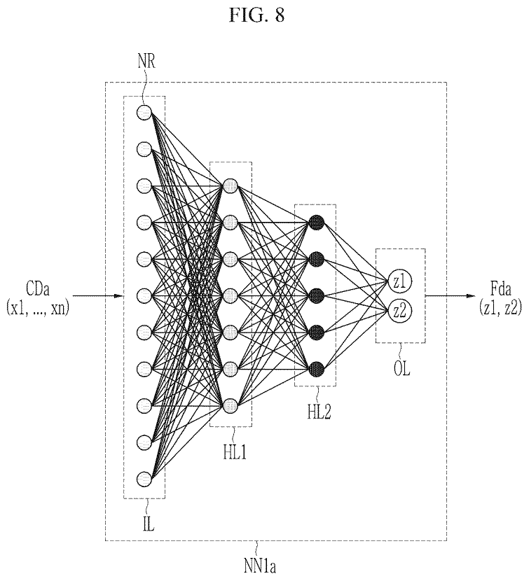

The first neural network NN1a of FIG. 8 may be an example of the first neural network NN1, which may be a graph neural network included in the GNN encoder module 730. Referring to FIG. 8 as an example, the first neural network NN1a may include at least one node. Nodes included in the first neural network NN1a may be interconnected by one or more links (which may have respective weights).

In some embodiments, in the first neural network NN1a, one or more nodes connected via links may form a relationship between input nodes and output nodes. Any node that is in an output neuron relationship to another is also in an input node relationship to the other node, and vice versa. As mentioned above, input neuron to output neuron relationships may be represented by links. One input node may be connected to more than one output node via a link, and vice versa.

In a relationship between input nodes and output nodes connected through a single link, the data of the output node may have its value determined based on the data input to the input node. Here, the links that interconnect input nodes and output nodes may have weights. Weights are variable and may be changed by the user or the algorithm to make the neural network perform the desired function. For example, if one or more input nodes are interconnected to one output node by respective links, the output node may determine the output node value based on the values input to the input nodes connected to the output node and the weights set to the links corresponding to each of the input nodes.

In the first neural network NN1a, one or more nodes NRs are interconnected through one or more links to form input node and output node relationships within the neural network. The characteristics of the first_a neural network NN1a may be determined according to the number of nodes NR and links in the first_a neural network NN1a, the correlation between the nodes NR and links, and the value of the weight assigned to each link.

The first_a neural network NN1a may include an input layer IL, hidden layers HL1, HL2, and an output layer OL. Each of the input layer IL, hidden layers HL1, HL2, and output layer OL may include at least one node NR.

According to an embodiment, the first_a neural network NN1a has an encoder structure, and the number of nodes NR may decrease as it progresses to the input layer IL, hidden layers HL1, HL2, and output layer OL.

The nodes NR included in the input layer IL may directly receive the circuit “a” data CDa corresponding to the first and second circuit data CD1, CD2 (which may be directly input (possibly with minor alteration) without going through a link in the relationship with other nodes among the nodes NR in the first_a neural network NN1a. Alternatively, in the first_a neural network NN1a, nodes NR that do not have other input nodes connected thereto by links are input nodes.

The circuit “a” data CDa is an example of circuit data and may be generated by performing a vectorization or flattening operation based on the first_a and the second_a circuit data CD1a, CD2a. The circuit “a” data CDa may have n-dimensional data and may include x1 to xn as elements, where n is an integer greater than or equal to 3. The data types of x1 to xn may be any of various numeric types, character types, and set types including integers/real numbers, but examples of the data types are not limited thereto.

In some embodiments, the nodes NR included in the output layer OL may be those that do not have an output node relationship with any other nodes among the nodes NR in the first neural network NN1. The output layer OL may output the a feature data Fda corresponding to the circuit “a” data CDa as the output value of the first neural network NN1.

The feature “a” data Fda may be an embedding vector encoded by the first_a neural network NN1a based on the circuit “a” data CDa. According to an embodiment, the feature “a” data Fda may be an embedding vector or a bottleneck layer encoded by the first_a neural network NN1a, and the data dimension of the feature “a” data Fda may be lower than the data dimension of the circuit “a” data CDa.

The feature “a” data Fda is data with two dimensions and may include z1 and z2 as elements. The data type of each z1 and z2 may be any of various numeric types such an integer type/real number type, a character type, a set type, etc., but examples of the data types are not limited thereto. In FIG. 8, the feature “a” data Fda is illustrated as having two-dimensional data, but implementations are not limited to two-dimensional data.

The circuit design device 10 in some embodiments may efficiently search for an optimal arrangement of a large-scale circuit structure including circuit elements through the encoding operation of step S130.

The policy module 740 generates 1-dimension circuit placement data 1DPd based on the feature data Fd of the reinforcement learning process (S140).

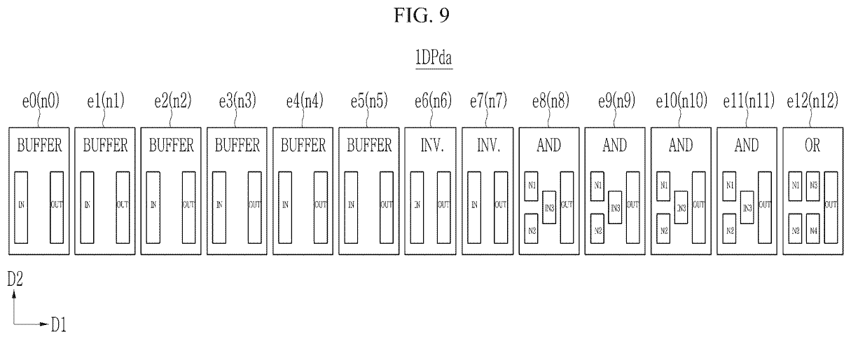

The 1-dimension circuit placement data “a” 1DPda of FIG. 9 is an example of the 1-dimension circuit placement data 1DPd generated based on the feature “a” data Fda. In the example of FIG. 9, the policy module 740 may generate the 1-dimension circuit placement data “a” 1DPda based on the feature “a” data Fda for the first_a and second_a circuit data CD1a, CD2a.

The 1-dimension “a” circuit placement data 1DPda may include a circuit structure in which the 0th to 12th elements e0 to e12 are sequentially arranged in the first direction D1. Each of the 0th to 12th elements e0 to e12 may correspond to the 0th to 12th nodes n0 to n12, respectively.

The 1-dimension “a” circuit placement data 1DPda may be data of a numerical sequence or a character string corresponding to (and indicating) the placement order of the 0th to 12th nodes n0 to n12. For example, the 1-dimension circuit placement data “a” 1DPda may be represented as {0, 1, 2, 3, 4, 5, 6, 7, 8, 9, 10, 11, 12}.

The cost function module 720 generates the total wiring length TWL and the number of maximum congestion wires MC based on 1-dimension circuit placement data 1DPd (S150).

The cost function module 720 may generate information about wires connected between circuit elements of the 1-dimension circuit placement data 1DPd based on the 1-dimension circuit placement data 1DPd.

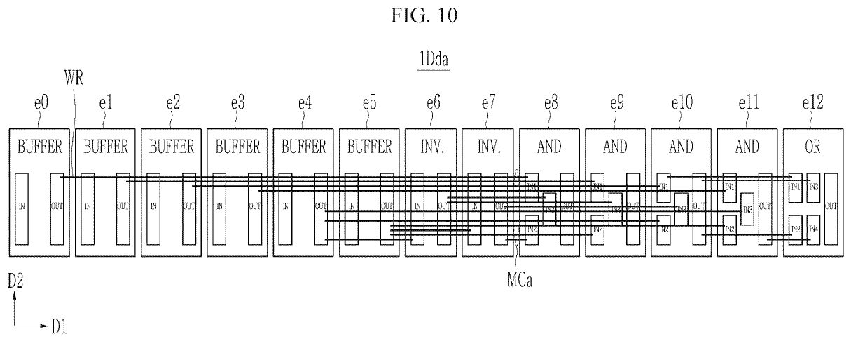

FIG. 10 illustrates an example of the placement of wires connected between circuit elements for the 1-dimension “a” circuit placement data 1DPda. Referring to FIG. 10 as an example, the cost function module 720 may generate information on wires WR connected between the 0th to 12th elements e0 to e12 based on the 1-dimension “a” circuit placement data 1DPda.

Based on the hyperedge of the second_a circuit data CD2a, the wirings WR may include 18 wirings and may include wirings extending in the first direction D1 between the input ports and the output ports of the 0th to 12th elements e0 to e12. Wires WR may extend in a first direction D1 on a circuit structure of the 1-dimension circuit placement data “a” 1DPda.

The cost function module 720 may generate a total “a” wiring length TWLa which is a total length of the wirings WR and may also generate a number of maximum congestion wires MCa for the wirings WR based on information about the wirings WR.

The number of maximum congestion wires MCa may be the maximum number of wirings spaced apart from each other in the second direction D2 in the circuit structure of the 1-dimension circuit placement data “a” 1DPda. The cost function module 720 may search for a section in which the circuit structure of the a 1-dimension circuit placement data 1DPda is densely arranged in the second direction D2, and then generate the number of maximum congestion wires MCa. Referring to FIG. 10 as an example, the number of maximum congestion wires MCa for the 1-dimension circuit placement data “a” 1DPda may be 11, which is the number of wirings extending between the 7th element e7 and the 8th element e8.

The cost function module 720 checks whether the termination criteria for the reinforcement learning process is satisfied (S160).

The cost function module 720 may check whether the termination criteria for the reinforcement learning process are satisfied based on the total wiring length TWL and the number of maximum congestion wires MC.

According to an embodiment, the cost function module 720 may check whether the equation 2 is satisfied for the 1-dimension circuit placement data “a” 1DPda, and check whether the number of the 1-dimension circuit placement data “a” 1DPda satisfying the equation 2 is equal to or greater than a predetermined number.

If the cost function module 720 determines in step S160 that the termination criteria for the reinforcement learning process is not satisfied, the circuit design device 10 may perform steps S140, S150, and S160 after performing steps S170 and S180 described below.

When the cost function module 720 determines in step S160 that the termination criteria for the reinforcement learning process is satisfied, the circuit design device 10 may terminate the reinforcement learning process according to the embodiment.

When the cost function module 720 determines that the termination criteria for the reinforcement learning process is not satisfied, the reinforcement learning neural network 750 performs a learning operation based on the sample data SPd (S170).

In the case where the cost function module 720 determines that the termination criteria for the reinforcement learning process is not satisfied, the reinforcement learning neural network 750 may receive sample data SPd including the 1-dimension circuit placement data “a” 1DPda and the a total wiring length TWLa and the number of maximum congestion wires MCa corresponding to the 1-dimension circuit placement data “a” 1DPda.

A reinforcement learning neural network 750 may perform a learning operation for a policy module 740 based on sample data SPd.

The reinforcement learning neural network 750 updates the policy module 740 through learning operation (S180).

A reinforcement learning neural network 750 may generate update data UPd for a policy module 740 through learning operations. Update data UPd may be provided to the policy module 740, and the policy module 740 may be updated based on the update data UPd.

Thereafter, the updated policy module 740 may perform step S140.

A circuit design device 10 according to an embodiment may generate 1-dimension circuit placement data 1DPd for a circuit graph CG that reflects design constraints such as node information and the number of maximum congestion wires MC and minimize the total wiring length TWL, through a circuit design method using the reinforcement learning process as described above.

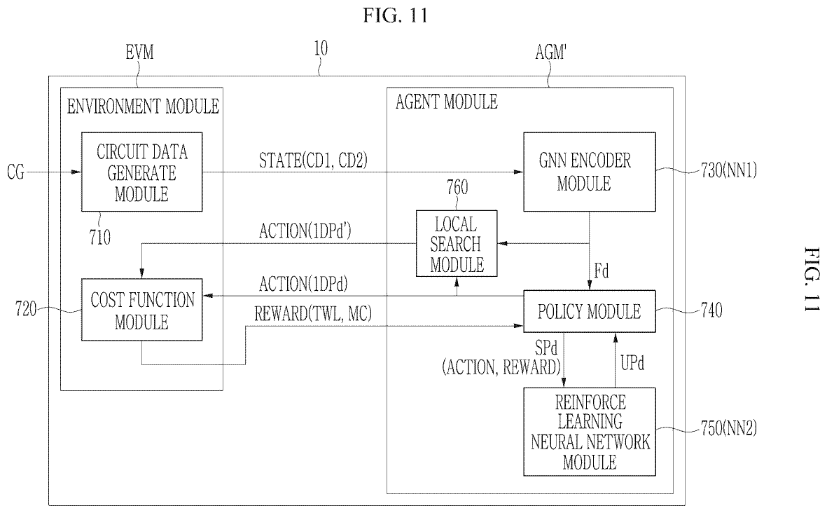

FIG. 11 illustrates a circuit design system according to one or more embodiments. The circuit design system of FIG. 11 may correspond to the circuit design system of FIG. 2, and each environment module EVM and agent module AGM′ in FIG. 11 may correspond to the environment module EVM and agent module AGM of FIG. 2, respectively. For explanation below, the description below of circuit design system of FIG. 11 highlights differences over the circuit design system of FIG. 2.

Referring to FIG. 11, the agent module AGM′ may further include a local search module 760, rather than the agent module AGM of FIG. 2.

The local search module 760 may receive 1-dimension circuit placement data 1DPd and feature data Fd, and perform a post-processing operation on the 1-dimension circuit placement data 1DPd. The local search module 760 may, in the post-processing operation, change the arrangement of nodes in the 1-dimension circuit placement data 1DPd and/or the arrangement order of the nodes based on the node information included in the feature data Fd, thereby generating the post-processing 1-dimension circuit placement data 1DPd′.

For example, the local search module 760 may generate post-processing 1-dimension circuit placement data 1DPd′ by following the node information of the first circuit data CD1 and changing the arrangement of nodes in the 1-dimension circuit placement data 1DPd and/or the arrangement order of the nodes.

The post-processing 1-dimension circuit placement data 1DPd′ may be provided to the cost function module 720 of the environment module EVM. The cost function module 720 may calculate the total wiring length TWL, the number of maximum congestion wires MC, and the maximum wiring length corresponding to the post-processing 1-dimension circuit placement data 1DPd′. The total wiring length TWL, the number of maximum congestion wires MC, and the maximum wiring length corresponding to the post-processing 1-dimension circuit placement data 1DPd′ may be provided to the agent module AGM′.

The circuit design device 10 may search for an approximate solution of a reinforcement learning process through a local search module 760 and easily find an optimal action among a set of actions. The local search module 760 may operate independently or complementarily from the learning of the policy module 740 of the reinforcement learning process and improve the search efficiency of the circuit design device 10.

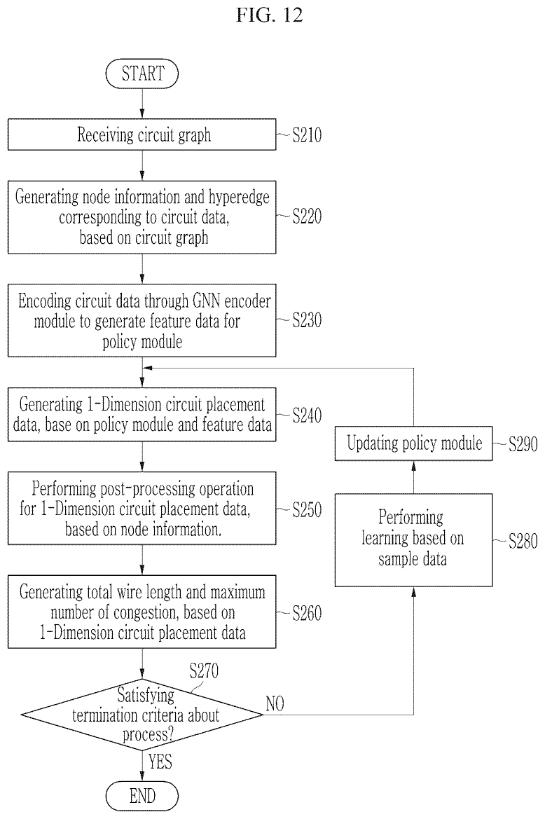

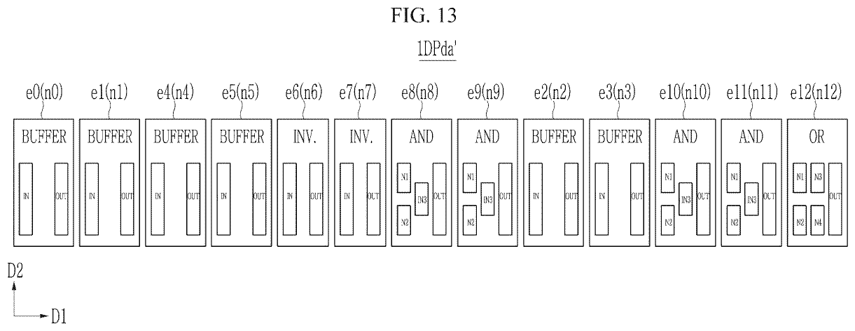

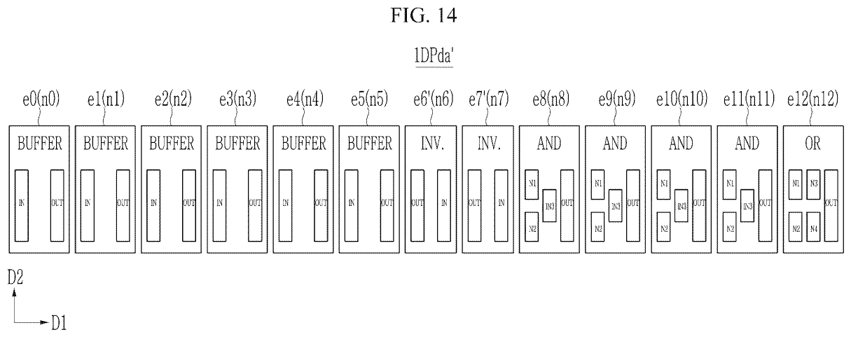

FIG. 12 illustrates a circuit design method according to one or more embodiments. FIGS. 13 and 14 are drawings for explaining circuit design methods according to some embodiments.

The circuit design method of FIG. 12 may correspond to the circuit design method of FIG. 3. The circuit design method is described below with comparison to the circuit design method of FIG. 3.

Referring to FIGS. 11 and 12, the circuit data generation module 710 receives a circuit graph CG (S210). Step S210 may correspond to step S110, and step S210 may generally be performed as step S110.

The circuit data generation module 710 generates first and second circuit data CD1, CD2 based on the circuit graph CG (S220). Step S220 may correspond to step S120, and step S210 may generally be performed as step S110.

The GNN encoder module 730 encodes the first and second circuit data CD1, CD2 to generate feature data Fd for the policy module 740 (S230). Step S230 may correspond to step S130, and step S230 may generally be be performed as step S130.

The policy module 740 generates 1-dimension circuit placement data 1DPd based on feature data Fd (S240). Step S240 may correspond to step S140, and S240 may generally be performed as step S140.

The local search module 760 performs a post-processing operation on the 1-dimension circuit placement data 1DPd based on the node information included in the feature data Fd to generate post-processing 1-dimension circuit placement data 1DPd′ (S250).

The local search module 760 may change the arrangement of nodes in the 1-dimension circuit placement data 1DPd and/or the arrangement order of the nodes based on the node information included in the feature data Fd in the post-processing operation, thereby generating the post-processing 1-dimension circuit placement data 1DPd′.

The post-processing 1-dimension circuit placement data “a” 1DPda′ of FIG. 13 is an example of the post-processing 1-dimension circuit placement data 1DPd′ generated based on the 1-dimension circuit placement data “a” 1DPda. Referring to FIG. 13 as an example, the local search module 760 may change the arrangement order of nodes of the a 1-dimension circuit placement data 1DPda based on node information of the a feature data Fda corresponding to the 1-dimension circuit placement data “a” 1DPda, thereby generating the post-processing 1-dimension circuit placement data “a” 1DPda′. The local search module 760 may change the arrangement order of the in the 1-dimension circuit placement data “a” 1DPda based on the node information of the a feature data Fda and the macro cell application of the 12th node n12 of the first_a circuit data CD1a in FIG. 5. According to an embodiment, the post-processing 1-dimension circuit placement data “a” 1DPda′ (a node ordering) may be represented as {0, 1, 4, 5, 6, 7, 8, 9, 2, 3, 10, 11, 12}.

The post-processing 1-dimension circuit placement data “a” 1DPda′ of FIG. 14 is an example of the post-processing 1-dimension circuit placement data 1DPd′ generated based on the 1-dimension circuit placement data “a” 1DPda. Referring to FIG. 14 as an example, the local search module 760 may change the arrangement of nodes of the 1-dimension circuit placement data “a” 1DPda based on node information of the feature data “a” Fda corresponding to the 1-dimension circuit placement data “a” 1DPda, thereby generating the post-processing 1-dimension circuit placement data “a” 1DPda′. The local search module 760 may determine whether to apply the flip of the first_a circuit data CD1a in FIG. 5 based on the node information of the data “a” Fda, and change the placement in the first direction D1 for the 6th node n6 and the 7th node n7 in the a 1-dimension circuit placement data “a” 1DPda. In the given example, the a post-processing 1-dimension circuit placement data “a” 1DPda′ may be represented as {0, 1, 2, 3, 4, 5, 6′, 7′, 8, 9, 10, 11, 12}.

The cost function module 720 generates the total wiring length TWL and the number of maximum congestion wires MC based on the 1-dimension circuit placement data 1DPd and the post-processing 1-dimension circuit placement data 1DPd′ (S260). Step S260 may be generally performed as S150; differences of Step S260 over step S150 are described below.

The cost function module 720 may generate information about wires connected between circuit elements of the 1-dimension circuit placement data 1DPd based on the 1-dimension circuit placement data 1DPd. Additionally, the cost function module 720 may generate information about wires connected between circuit elements of the post-processing 1-dimension circuit placement data 1DPd′ based on the post-processing 1-dimension circuit placement data 1DPd′.

The cost function module 720 checks whether the termination criteria for the reinforcement learning process is satisfied (S270). Step S270 may correspond to step S160, and may generally be performed as step S160.

In the case where the cost function module 720 determines in step S270 that the termination criteria for the reinforcement learning process is not satisfied, the circuit design device 10 may perform steps S240, S250, S260, and S270 after performing steps S280 and S290 described below.

In the case where the cost function module 720 determines in step S270 that the termination criteria for the reinforcement learning process is satisfied, the circuit design device 10 may terminate the reinforcement learning process.

In the case where the cost function module 720 determines that the termination criteria for the reinforcement learning process is not satisfied, in step S280 the reinforcement learning neural network 750 performs a learning operation based on the sample data SPd. Step S280 may correspond to step S170, and step S280 may generally be performed as step S170.

The reinforcement learning neural network 750 updates the policy module 740 through learning operations (S290). Step S290 may correspond to step S180, and S290 may generally be performed as step S180.

Thereafter, the updated policy module 740 may perform step S240.

A circuit design device 10 according to an embodiment may generate 1-dimension circuit placement data 1DPd for a circuit graph CG that reflects design constraints such as node information and the number of maximum congestion wires MC and that minimizes the total wiring length TWL through a circuit design method using the reinforcement learning process as described above.

The computing apparatuses, the electronic devices, the processors, the memories, the information output system and hardware, the storage devices, and other apparatuses, devices, units, modules, and components described herein, including descriptions with respect to respect to FIGS. 1-14, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-14 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A circuit design method comprising:
receiving a circuit graph;
based on the circuit graph, generating circuit data including node information for nodes in the circuit graph and a hyperedge defining connection relationships between the nodes;
encoding the circuit data through a graph neural network to generate feature data for a policy module;
generating circuit placement data for the nodes based on the policy module and the feature data;
generating a total wiring length for the circuit placement data based on the circuit placement data; and
determining whether a termination criterion for additional generation of the circuit placement data is satisfied.

2. The circuit design method of claim 1, wherein:
the node information includes, for each of the nodes, the size of the node, the number of ports of the node, whether the node is a group, whether the node is flipped, and whether the node is a macro cell.

3. The circuit design method of claim 1, wherein:
the hyperedge includes connection information indicating connections between the nodes and at least one of an adjacency matrix and an incidence matrix.

4. The circuit design method of claim 1, wherein:
the generating the feature data includes the graph neural network receiving the circuit data and encoding the circuit data,
wherein the number of dimensions of the feature data is lower than the number of dimensions of the circuit data.

5. The circuit design method of claim 4, wherein:
the graph neural network includes a HGNN (Hypergraph Neural Network), an HCHA (Hypergraph Convolution via Hyperedge Attention) neural network, a HyperGCN (Hypergraph Convolutional Network), or a Hyper-SAGN (Hypergraph Self-Attention Graph Neural Network).

6. The circuit design method of claim 1, wherein:
the generating the total wiring length includes generating the number of maximum congestion wires corresponding to the circuit placement data,
wherein the circuit placement data is used as an action in a reinforcement learning process, and
wherein the total wiring length and the number of maximum congestion wires are used as rewards of the reinforcement learning process.

7. The circuit design method of claim 1, wherein:
the determining whether the termination criterion for additional generation of the circuit placement data is satisfied includes checking whether the following equation is satisfied:
TWL(IDPd)<TH1 and MC(1DPd)<TH2,
wherein IDPd is the circuit placement data, TWL is the total wiring length, the MC is the number of maximum congestion wires, and TH1 and TH2 are predetermined constants.

8. The circuit design method of claim 1, further comprising:
performing a learning operation based on the circuit placement data and the total wiring length in response to not satisfying the termination criterion; updating the policy module based on the learning operation; and generating the circuit placement data and the total wiring length based on the updated policy module.

9. The circuit design method of claim 1, further comprising:
performing a post-processing operation on the circuit placement data to generate post-processing circuit placement data;
wherein the post-processing circuit placement data and the circuit placement data are provided to an environment module.

10. The circuit design method of claim 9, wherein:
the post-processing operation includes changing the arrangement of nodes in the circuit placement data and the arrangement order of the nodes based on the node information.

11. A circuit design device comprising:
one or more processors and a memory storing code configured to, when executed by the one or more processors, cause the circuit design device to perform a process comprising:
receiving a circuit graph;
based on the circuit graph, generating circuit data including node information for nodes in the circuit graph and a hyperedge defining connection relationships between the nodes;
encoding the circuit data through a graph neural network to generate feature data for a policy module;
generating circuit placement data for the nodes based on the policy module and the feature data;
generating a total wiring length for the circuit placement data based on the circuit placement data; and
determining whether a termination criterion for additional generation of the circuit placement data is satisfied.

12. The circuit design device of claim 11, wherein:
the node information includes, for each of the nodes, the size of the node, the number of ports of the node, whether the node is a group, whether the node is flipped, and whether the node is a macro cell.

13. The circuit design device of claim 11, wherein:
the hyperedge includes connection information indicating connections between the nodes and at least one of an adjacency matrix and an incidence matrix.

14. The circuit design device of claim 11, wherein:
the generating the feature data includes the graph neural network receiving the circuit data and encoding the circuit data,
wherein the number of dimensions of the feature data is lower than the number of dimensions of the circuit data.

15. The circuit design device of claim 14, wherein:
the graph neural network includes an HGNN, an HCHA network, a HyperGCN, or a Hyper-SAGN.

16. The circuit design device of claim 11, wherein:
the generating the total wiring length includes generating the number of maximum congestion wires corresponding to the circuit placement data,
wherein the circuit placement data is used as an action of a reinforcement learning process, and
wherein the total wiring length and the number of maximum congestion wires are used as rewards of the reinforcement learning process.

17. The circuit design device of claim 11, wherein the process further comprises:
in response to not satisfying the termination criterion, performing a learning operation based on the circuit placement data and the total wiring length; updating the policy module based on the learning operation; and generating the circuit placement data and the total wiring length based on the updated policy module.

18. The circuit design device of claim 11, wherein the process further comprises performing a post-processing operation on the circuit placement data based on the node information to generate post-processing circuit placement data, and
wherein the post-processing operation includes changing arrangement of nodes in the circuit placement data or changing arrangement order of the nodes based on the node information.

19. A circuit design device, comprising:
an environment module configured to receive a circuit graph and generate, based on the circuit graph, circuit data including node information for nodes in the circuit graph and a hyperedge defining connection relationships between the nodes; and
an agent module configured to encode the circuit data through a graph neural network to generate feature data for a policy module, output circuit placement data for the nodes based on the policy module and the feature data, receive a total wiring length of the circuit placement data, and perform learning for the policy module based on the circuit placement data and the total wiring length.

20. The circuit design device of claim 19, wherein:
the environment module is configured to receive the circuit placement data, generate the total wiring length and the number of maximum congestion wires corresponding to the circuit placement data, and provide the total wiring length and the number of maximum congestion wires to the agent module.
